(19) United States
(12) Patent Application Publication
(10) Pub. No.: US 2026/0308467 A1
(43) Pub. Date: Oct. 8, 2026

(54) CONVERTING A LIPID FEEDSTOCK TO JET FUEL

(71) Applicant: CHEVRON U.S.A. INC., San Ramon, CA (US)

(72) Inventors: Krege Matthew CHRISTISON, Martinez, CA (US); Sven Ivar HOMMELTOFT, Pleasant Hill, CA (US); Michelle Kimberly YOUNG, Manvel, TX (US); Horacio TREVINO, Richmond, CA (US); David VUILLEUMIER, Oakland, CA (US)

(21) Appl. No.: 19/637,876

(22) Filed: Apr. 2, 2026

Related U.S. Application Data
(60) Provisional application No. 63/783,804, filed on Apr. 4, 2025.

(51) Int. Cl. C10L 1/06; C10G 3/00

(52) U.S. Cl. CPC C10L 1/06; C10G 3/48; C10G 2300/70; C10G 2400/08; C10L 2200/043; C10L 2270/04; C10L 2290/24

(57) ABSTRACT

A lipid feedstock including fatty acid glycerol esters is flowed into a reaction vessel including a metal oxide catalyst on an oxide support, which catalytically converts the feedstock into a mixture including an intermediate composition having at least 70% of its oxygen within ketone groups. A synthetic component having a boiling range of about 120-300° C. is obtained by (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture. The synthetic component is used as jet fuel, or in a jet fuel blend, having a flash point of about 38° C. or more, freeze point of about −40° C. or less, viscosity at −20° C. of about 8 mm²/s or less, and viscosity at −40° C. of about 12 mm²/s or less.

### CROSS-REFERENCE TO RELATED APPLICATIONS

The present application claims the benefit of U.S. Provisional Patent Application No. 63/783,804, filed Apr. 4, 2025 and titled “CONVERTING A LIPID FEEDSTOCK TO JET FUEL,” the entire contents of which are incorporated by reference herein.

### FIELD

This application generally relates to renewable fuels.

### BACKGROUND

There is an increasing interest in using lipid feedstocks, such as derived from plants, algae, animals, or microbiological organisms, to generate renewable fuels to replace or supplement fossil fuels. However, it may require several conventional steps to convert a lipid feedstock to a conventional renewable fuel, which may increase the time and expense of such conversion.

### SUMMARY

Methods and systems for converting a lipid feedstock to jet fuel are provided herein.

Some examples herein provide a method of generating a fuel blend. The method may include flowing a lipid feedstock including fatty acid glycerol esters into a reaction vessel including a metal oxide catalyst on an oxide support. The method may include using the metal oxide catalyst in the reaction vessel to catalytically convert the lipid feedstock into a mixture including an intermediate composition having at least 70% of its oxygen within ketone groups. The method may include obtaining a synthetic blending component having a boiling range of about 120° C. to about 300° C. using operations including either (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture. The method may include blending the synthetic blending component with a second blending component to create a jet fuel blend having a flash point of about 38° C. or more, a freeze point of about −40° C. or less, a viscosity at −20° C. of about 8 mm²/s or less, and a viscosity at −40° C. of about 12 mm²/s or less.

In some examples, about 1-99 vol % of the jet fuel blend is the synthetic blending component.

In some examples, about 1-50 vol % of the jet fuel blend is the synthetic blending component. In some examples, the second blending component includes a conventional blending component, and the jet fuel blend meets the Table 1 specifications of the ASTM D7566 standard, other than the requirement that the synthetic blending component is specified in one of Annexes A1-A8. In some examples, the second blending component includes a second synthetic blending component, and the jet fuel blend meets the Table 1 specifications of the ASTM D7566 standard, other than the requirements that the synthetic blending component is specified in one of Annexes A1-A8 and that the second blending component be a conventional blending component.

In some examples, about 50-99 vol % of the jet fuel blend is the synthetic blending component. In some examples, the second blending component includes a conventional blending component, and the jet fuel blend meets the Table 1 specifications of the ASTM D7566 standard, other than the requirements that the synthetic blending component is specified in one of Annexes A1-A8 and that no more than 50 vol % of the jet fuel blend be the synthetic blending component. In some examples, the second blending component includes a second synthetic blending component, and the jet fuel blend meets the Table 1 specifications of the ASTM D7566 standard, other than the requirements that the synthetic blending component is specified in one of Annexes A1-A8, that no more than 50 vol % of the jet fuel blend be the synthetic blending component, and that the second blending component be a conventional blending component.

In some examples, the second blending component includes hydrotreated jet boiling range material from lipids processed through an FCC unit. In some examples, the second blending component includes ASTM D7566 Annex A6 synthetic blending component. In some examples, the second blending component includes ASTM D7566 Annex A8 synthetic blending component. In some examples, the jet fuel blend includes about 8-25 vol % aromatics, and the jet fuel blend meets the Table 1 specifications of the ASTM D7566 standard, other the requirement that the second blending component be a conventional blending component.

In some examples, the jet fuel blend includes about 1-8 vol % aromatics.

In some examples, the synthetic blending component has a normally distributed carbon number distribution ranging from C7-C18 with about 20-30 mass % n-paraffins, about 25-35 mass % i-paraffins, about 35-45 mass % cycloparaffins, and about 0-10% mass aromatics.

In some examples, the jet fuel blend consists essentially of sustainable aviation fuel.

In some examples, the jet fuel blend consists essentially of the synthetic blending component and the second blending component.

In some examples, the jet fuel blend has a freeze point of less than about −47° C.

In some examples, the second blending component has a viscosity at −40° C. of more than 12 mm²/s.

In some examples, either the cut or the mixture further is isomerized.

In some examples, the lipid feedstock has a TAN of about 10 mg KOH/g.

In some examples, the jet fuel blend has a TAN of less than about 0.1 mg KOH/g.

In some examples, the hydroprocessing is performed adiabatically.

Some examples herein provide a jet fuel blend. The jet fuel blend may include a synthetic blending component having a generally normally distributed carbon number distribution ranging from C7-C18 with about 20-30 mass % n-paraffins, about 25-35 mass % i-paraffins, about 35-45 mass % cycloparaffins, and about 0-10% mass aromatics; and a second blending component. The jet fuel blend may have a flash point of about 38° C. or more, a freeze point of about −40° C. or less, a viscosity at −20° C. of about 8 mm²/s or less, and a viscosity at −40° C. of about 12 mm²/s or less.

Some examples herein provide a jet fuel blend. The jet fuel blend may include a synthetic blending component made using operations including flowing a lipid feedstock including fatty acid glycerol esters into a reaction vessel including a metal oxide catalyst on an oxide support. The operations further may include using the metal oxide catalyst in the reaction vessel to catalytically convert the lipid feedstock into a mixture including an intermediate composition having at least 70% of its oxygen within ketone groups. The operations further may include obtaining a synthetic blending component having a boiling range of about 120° C. to about 300° C. using operations including either (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture. The jet fuel blend further may include a second blending component. The jet fuel blend may have a flash point of about 38° C. or more, a freeze point of about −40° C. or less, a viscosity at −20° C. of about 8 mm²/s or less, and a viscosity at −40° C. of about 12 mm²/s or less.

In some examples of the above jet fuel blend(s), about 1-99 vol % of the jet fuel blend is the synthetic blending component.

In some examples of the above jet fuel blend(s), about 1-50 vol % of the jet fuel blend is the synthetic blending component. In some examples, the second blending component includes a conventional blending component, and the jet fuel blend meets the Table 1 specifications of the ASTM D7566 standard, other than the requirement that the synthetic blending component is specified in one of Annexes A1-A8. In some examples, the second blending component includes a second synthetic blending component, and the jet fuel blend meets the Table 1 specifications of the ASTM D7566 standard, other than the requirements that the synthetic blending component is specified in one of Annexes A1-A8 and that the second blending component be a conventional blending component.

In some examples of the above jet fuel blend(s), about 50-99 vol % of the jet fuel blend is the synthetic blending component. In some examples, the second blending component includes a conventional blending component, and the jet fuel blend meets the Table 1 specifications of the ASTM D7566 standard, other than the requirements that the synthetic blending component is specified in one of Annexes A1-A8 and that no more than 50 vol % of the jet fuel blend be the synthetic blending component. In some examples, the second blending component includes a second synthetic blending component, and the jet fuel blend meets the Table 1 specifications of the ASTM D7566 standard, other than the requirements that the synthetic blending component is specified in one of Annexes A1-A8, that no more than 50 vol % of the jet fuel blend be the synthetic blending component, and that the second blending component be a conventional blending component.

In some examples of the above jet fuel blend(s), the second blending component includes hydrotreated jet boiling range material from lipids processed through an FCC unit. In some examples of the above jet fuel blend(s), the second blending component includes ASTM D7566 Annex A6 synthetic blending component. In some examples of the above jet fuel blend(s), the second blending component includes ASTM D7566 Annex A8 synthetic blending component. In some examples, the jet fuel blend includes about 8-25 vol % aromatics, and the jet fuel blend meets the Table 1 specifications of the ASTM D7566 standard, other the requirement that the second blending component be a conventional blending component.

In some examples of the above jet fuel blend(s), the jet fuel blend includes about 1-8 vol % aromatics.

In some examples of the above jet fuel blend(s), the synthetic blending component has a normally distributed carbon number distribution ranging from C7-C18 with about 20-30 mass % n-paraffins, about 25-35 mass % i-paraffins, about 35-45 mass % cycloparaffins, and about 0-10% mass aromatics.

In some examples of the above jet fuel blend(s), the jet fuel blend consists essentially of sustainable aviation fuel.

In some examples of the above jet fuel blend(s), the jet fuel blend consists essentially of the synthetic blending component and the second blending component.

In some examples of the above jet fuel blend(s), the jet fuel blend has a freeze point of less than about −47° C.

In some examples of the above jet fuel blend(s), the second blending component has a viscosity at −40° C. of more than 12 mm²/s.

In some examples of the above jet fuel blend(s), either the cut or the mixture further is isomerized.

In some examples of the above jet fuel blend(s), the lipid feedstock has a TAN of about 10 mg KOH/g.

In some examples of the above jet fuel blend(s), the jet fuel blend has a TAN of less than about 0.1 mg KOH/g.

Some examples herein provide a method of generating a jet fuel. The method may include flowing a lipid feedstock including fatty acid glycerol esters into a reaction vessel including a metal oxide catalyst on an oxide support. The method may include using the metal oxide catalyst in the reaction vessel to catalytically convert the lipid feedstock into a mixture including an intermediate composition having at least 70% of its oxygen within ketone groups. The method may include obtaining a jet fuel having a boiling range of about 120° C. to about 300° C., a flash point of about 38° C. or more, a freeze point of about −40° C. or less, a viscosity at −20° C. of about 8 mm²/s or less, and a viscosity at −40° C. of about 12 mm²/s or less, using operations including either (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture.

In some examples, the jet fuel meets the Table 1 specifications of ASTM D1655.

In some examples, the jet fuel meets the Table 1 specifications of the ASTM D7566 standard, other than the requirement that the jet fuel be a jet fuel blend including a conventional blending component and a synthetic blending component specified in one of Annexes A1-A8.

In some examples, the jet fuel includes about 1-8 vol % aromatics.

In some examples, the jet fuel has a normally distributed carbon number distribution ranging from C7-C18 with about 20-30 mass % n-paraffins, about 25-35 mass % i-paraffins, about 35-45 mass % cycloparaffins, and about 0-10% mass aromatics.

In some examples, the jet fuel has a freeze point of less than about −47° C.

In some examples, either the cut or the mixture further is isomerized.

In some examples, the lipid feedstock has a TAN of about 10 mg KOH/g.

In some examples, the jet fuel has a TAN of less than about 0.1 mg KOH/g.

In some examples, the hydroprocessing is performed adiabatically.

Some examples herein provide a jet fuel that includes a generally normally distributed carbon number distribution ranging from C7-C18 with about 20-30 mass % n-paraffins, about 25-35 mass % i-paraffins, about 35-45 mass % cycloparaffins, and about 0-10% mass aromatics. The jet fuel may have a flash point of about 38° C. or more, a freeze point of about −40° C. or less, a viscosity at −20° C. of about 8 mm²/s or less, and a viscosity at −40° C. of about 12 mm²/s or less.

Some examples herein provide a jet fuel that is made using operations including flowing a lipid feedstock including fatty acid glycerol esters into a reaction vessel including a metal oxide catalyst on an oxide support. The operations may include using the metal oxide catalyst in the reaction vessel to catalytically convert the lipid feedstock into a mixture including an intermediate composition having at least 70% of its oxygen within ketone groups. The operations may include obtaining a jet fuel having a boiling range of about 120° C. to about 300° C., a flash point of about 38° C. or more, a freeze point of about −40° C. or less, a viscosity at −20° C. of about 8 mm²/s or less, and a viscosity at −40° C. of about 12 mm²/s or less, using operations including either (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture.

In some examples of the above jet fuel(s), the jet fuel meets the Table 1 specifications of ASTM D1655.

In some examples of the above jet fuel(s), the jet fuel meets the Table 1 specifications of the ASTM D7566 standard, other than the requirement that the jet fuel be a jet fuel blend including a conventional blending component and a synthetic blending component specified in one of Annexes A1-A8.

In some examples of the above jet fuel(s), the jet fuel includes about 1-8 vol % aromatics.

In some examples of the above jet fuel(s), the jet fuel has a normally distributed carbon number distribution ranging from C7-C18 with about 20-30 mass % n-paraffins, about 25-35 mass % i-paraffins, about 35-45 mass % cycloparaffins, and about 0-10% mass aromatics.

In some examples of the above jet fuel(s), the jet fuel has a freeze point of less than about −47° C.

In some examples of the above jet fuel(s), either the cut or the mixture further is isomerized.

In some examples of the above jet fuel(s), the lipid feedstock has a TAN of about 10 mg KOH/g.

In some examples of the above jet fuel(s), the jet fuel has a TAN of less than about 0.1 mg KOH/g.

### BRIEF DESCRIPTION OF DRAWINGS

FIG. 1A illustrates an example flow of operations in method for converting a lipid feedstock to a jet fuel blend.

FIG. 1B illustrates an example flow of operations in method for converting a lipid feedstock to a jet fuel.

FIG. 2A schematically illustrates an example system for converting a lipid feedstock to a jet fuel or jet fuel blend.

FIG. 2B schematically illustrates another example system for converting a lipid feedstock to a jet fuel or jet fuel blend.

FIG. 3 is a plot of the viscosity at −40° C. of blends of the present synthetic blending component with high viscosity conventional jet fuel, or with low viscosity conventional jet fuel.

FIGS. 4A-4B are plots illustrating the bulk composition of the present synthetic blending component.

### DETAILED DESCRIPTION

A variety of renewable lipid feedstocks may be used to generate renewable fuels, such as sustainable aviation fuel (SAF). However, such conversion previously has been performed by directly hydroprocessing a lipid feedstock using a complex sequence of reaction steps including double bond saturation, hydro-deoxygenation, hydrocracking, and hydro-isomerization. In practice, such conversion process may use several reactors operating at high pressures (e.g., well in excess of 1000 psi hydrogen pressure). Additionally, because hydrogenation is highly exothermic, the rate at which such conversion process is performed may need to be severely restricted using recycle flow, thus limiting the conversion's overall throughput, e.g., by 50% or more. Still further, the lipid feedstock may need to be extensively pretreated to remove impurities that either may passivate the hydroprocessing catalysts (e.g., metals or phosphorous) or that may challenge the metallurgy of the hydroprocessing units (e.g., chlorides). These and other limitations of directly hydroprocessing a lipid feedstock may greatly limit throughput and increase cost and complexity, thus discouraging commercial implementation of SAF.

As provided herein, the present inventors have developed methods and systems for converting a lipid feedstock to a jet fuel or jet fuel blend meeting some or all of the requirements of the ASTM standards for Jet A and/or Jet A-1 fuels. In some examples, and as described in greater detail below, the present inventors have discovered that a lipid feedstock including fatty acid glycerol esters may be converted to finished aviation fuel meeting Jet A and/or Jet A-1 flash point, freeze point, and cold flow specifications. As discovered by the present inventors, the lipid feedstock may be catalytically converted into a mixture that includes an intermediate composition having at least 70% of its oxygen within ketone groups. The mixture then may be converted into a component which in some examples may be used directly as a jet fuel, and in other examples may be used in a jet fuel blend, which may meet Jet A and/or Jet A-1 flash point, freeze point, and cold flow specifications. The mixture may be converted to the component using any suitable order and combination of operations, for example using hydroprocessing followed by fractionation, or using fractionation followed by hydroprocessing. The hydroprocessing may be performed catalytically, using any suitable number and type(s) of catalyst to perform double bond (olefin) saturation reactions and hydrodeoxygenation reactions, and optionally also to perform an isomerization reaction. Such processing of the lipid feedstock substantially may not generate any carbon monoxide, and thus is compatible with noble metal catalysts which in some examples may be used for hydroprocessing. In comparison, direct hydroprocessing of lipids involves oxygen rejection, for example through the formation of water and carbon oxides. The present processing thus may be particularly useful in situations where reducing or eliminating the presence of carbon oxides is important. The conversion may be performed at less than 1000 psi hydrogen pressure, thus reducing cost and complexity of the present systems and methods as compared to conventional hydroprocessing of lipid feedstocks.

The intermediate composition may include significantly less oxygen than does the lipid feedstock from which the renewable fuel intermediate composition is made. Additionally, the intermediate composition may include significantly fewer impurities than does the lipid feedstock from which the renewable fuel intermediate composition is made. This reduction in impurities may occur during catalytic conversion of the lipid feedstock to the intermediate composition, as opposed to during additional, costly pretreating steps which are specifically intended to remove impurities. As such, processing a renewable fuel intermediate feedstock may reduce or eliminate the need to separately remove impurities, thus further reducing the cost and complexity of generating the finished jet fuel or jet fuel blend. In some examples, the renewable fuel intermediate composition may be produced from a lipid feedstock using a metal oxide catalyst on an oxide support. Further details regarding renewable fuel intermediate compositions, and their methods of production, are provided further below.

First, some example terms will be explained. Then, nonlimiting examples of the present methods and systems will be described.

### Example Terms

As used herein, the term “about” is intended to mean within 10% of the stated value.

As used herein, the term “primarily” is intended to mean a majority, e.g., at least half. Illustratively, a composition which primarily has components with boiling point above a certain level, means that at least half of the composition is made up of components with boiling point about that level. The term “primarily” encompasses all ranges from at least a half to 100%, e.g., 51% or more, about 60% or more, about 70% or more, about 80% or more, about 90% or more, or about 95% or more, or about 98% of more, or about 99% or more, or about 100%.

As used herein, the term “substantially” is intended to mean significantly. Illustratively, a concentration of a component within a first composition which is substantially less than the concentration of that component within a second composition, means that the concentration of that component within the first composition is less than about 20% of the concentration within the second composition, e.g., less than about 10%, less than about 5%, less than 1%, or even less. As another example, a reaction that is performed using substantially only certain components means that of all the components which are present at the reaction, at least about 80%, at least about 90%, at least about 95%, at least about 98%, at least about 99%, or about 100% are the certain components.

As used herein, the term “lipid” is intended to refer to a fatty acid; glyceride (e.g., monoglyceride or diglyceride); glycerolipid (e.g., triglyceride, also referred to as triacylglycerol, TAG, or neutral fat); phospholipid; or phosphoglyceride (also known as glycerophospholipid).

As used herein, the term “fatty acid” is intended to refer to a monocarboxylic acid having an aliphatic chain containing about 3 to 39 carbon atoms, illustratively about 7 to 23 carbon atoms. The aliphatic chain may be linear or branched, and may be saturated (e.g., may contain no carbon-carbon double bonds) or may be unsaturated (e.g., may contain one or more carbon-carbon double bonds).

As used herein, a “lipid feedstock” is intended to refer to a composition which is derived from a biological source, rather than from a fossil fuel source such as crude oil, shale oil, or coal, and primarily contains lipids. For example, a lipid feedstock may contain more than 50 wt % lipids, may contain more than 70 wt % lipids, may contain more than 85 wt % lipids, may contain more than 90 wt % lipids, may contain more than 95 wt % lipids, or more. A lipid feedstock may be derived from a plant, algae, animal, or microbiological organism. In some examples, a lipid feedstock may be derived from a low value waste material, side stream, by-product, residue, or sewage sludge. A lipid feedstock may be pretreated in a manner such as known in the art, for example, may be degummed, neutralized, bleached, and/or deodorized.

Depending on the source and the pretreatment (if any), a lipid feedstock may contain a mixture of different lipids. Illustratively, a lipid feedstock may include about 0-90 weight percent (wt %) of free fatty acids, about 5-100 wt % of fatty acid glycerol esters (e.g., monoglycerides, diglycerides, and/or triglycerides), and about 0-20 wt % of one or more compounds selected from the group consisting of: fatty acid esters of the non-glycerol type, fatty amides, and fatty alcohols. In some examples, the lipid feedstock may include more than about 50 wt % of free fatty acids and fatty acid glycerol esters, e.g., more than about 70 wt % of free fatty acids and fatty acid glycerol esters, or more than about 80 wt % of free fatty acids and fatty acid glycerol esters. The concentration of free fatty acids in a lipid feedstock may be characterized by determining the total acid number (TAN) of the feedstock, by measuring the mass of potassium hydroxide (KOH) in milligrams that is required to neutralize one gram of the lipid feedstock; see also ASTM D664. In some examples, a lipid feedstock may have a TAN of at least about 5 mg KOH/g, e.g., about 5-150 mg KOH/g, or about 10-150 mg KOH/g, or about 10-100 mg KOH/g, or about 10-50 mg KOH/g, or about 10-25 mg KOH/g, or about 10-20 mg KOH/g. A lipid feedstock may contain one or more impurities, such as phosphorous, silicon, chloride, an alkali metal such as sodium or potassium, an alkaline earth metal such as magnesium or calcium, a metal such as manganese or iron, or the like.

As used herein, the term “intermediate composition” is intended to refer to a liquid product that is produced from a lipid feedstock using a thermochemical process, and that may be used directly as a renewable fuel or may be further processed (e.g., blended into another fuel) to generate an at least partially renewable fuel. In some examples, the intermediate compositions provided herein may include less than about 70 wt % of an amount of oxygen in the lipid feedstock. An intermediate composition may include oxygenated hydrocarbons such as carboxylic acids, alcohols, ketones, aldehydes, and the like. In some examples, about 10 wt % to 50 wt % of the molecules of a liquid portion of the mixture includes oxygen, and about 50 wt % or more of the molecules of the liquid portion of the mixture do not include oxygen. In some examples, at least about 70 wt %, or at least about 80 wt %, of the oxygen in the liquid portion of the mixture is within ketone groups.

As used herein, the term “pyrolysis” is intended to refer to the thermal decomposition of organic materials in an oxygen-lean atmosphere (that is, an atmosphere containing significantly less oxygen than required for complete combustion).

As used herein, the term “hydroprocessing” is intended to refer to a process in which a composition is reacted with hydrogen in the presence of a catalyst under suitable conditions, e.g., elevated temperature and/or elevated pressure. Nonlimiting examples of hydroprocessing include hydrogenation, double bond saturation, hydrodeoxygenation, hydrocracking, hydro-isomerization, hydrodesulfurization, hydrodenitrogenation, hydrodearomatization, hydrodewaxing, and mild hydrocracking.

As used herein, the term “transportation fuel” refers to a fraction, cut, or blend of hydrocarbons having a distillation curve which is standardized for use in the transportation industry. For example, diesel fuel corresponds to a middle distillate from 160° C. to 380° C. (according to EN 590). As another example, aviation turbine fuel (also referred to as “jet fuel”) corresponds to a distillate from 160° C. to 300° C. (according to ASTM D1655). A “jet fuel blend” refers to jet fuel that is produced by blending two distinct components together, e.g., by blending a synthetic blending component, such as provided herein, together with either a conventional blending component or with a second synthetic blending component. Gasoline and naphtha are other standardized, well-characterized forms of transportation fuels. When a transportation fuel is derived from a lipid feedstock (e.g., via an intermediate composition in a manner such as provided herein), then the transportation fuel may be referred to herein as a “renewable fuel.” When a fuel (such as a transportation fuel, e.g., renewable fuel) is ready for use without substantial further processing, it may be referred to herein as a “final product.” The final product may be conveyed to a site of use in any suitable manner, e.g., by pipeline, truck, and/or rail.

As used herein, the term “ppm” is intended to refer to parts-per-million and is a weight-relative parameter. A ppm is a microgram per gram, such that a component that is present at 10 ppm in a composition is present at 10 micrograms of the component per 1 gram of the composition.

### Converting Lipid Feedstocks to Jet Fuel

As noted further above, conventional, previously known methods of processing lipid feedstocks into aviation turbine fuel may be complex, time consuming, and costly, and may use non-renewable resources. The present inventors have discovered that the present systems and methods may be used to efficiently and cost-effectively convert lipid feedstocks into finished jet fuel (including jet fuel blends) which may be at least partially or fully derived from renewable resources.

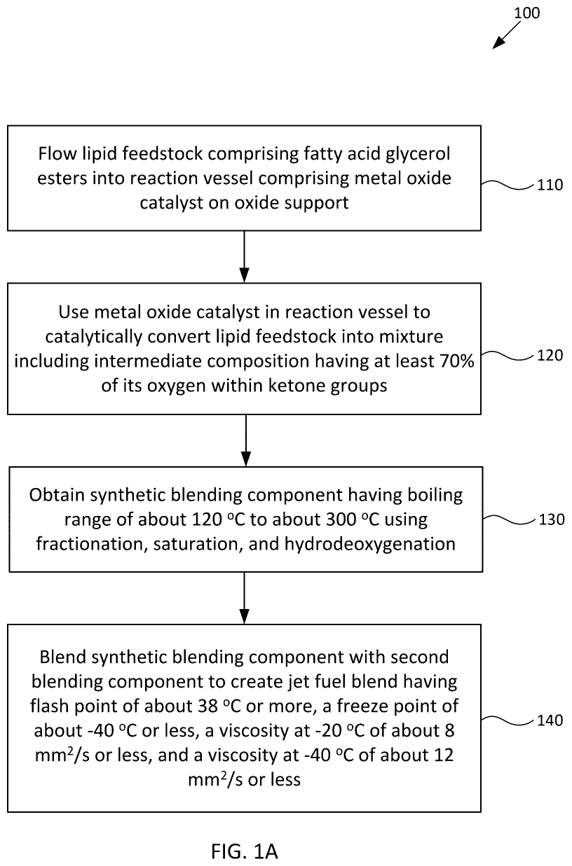

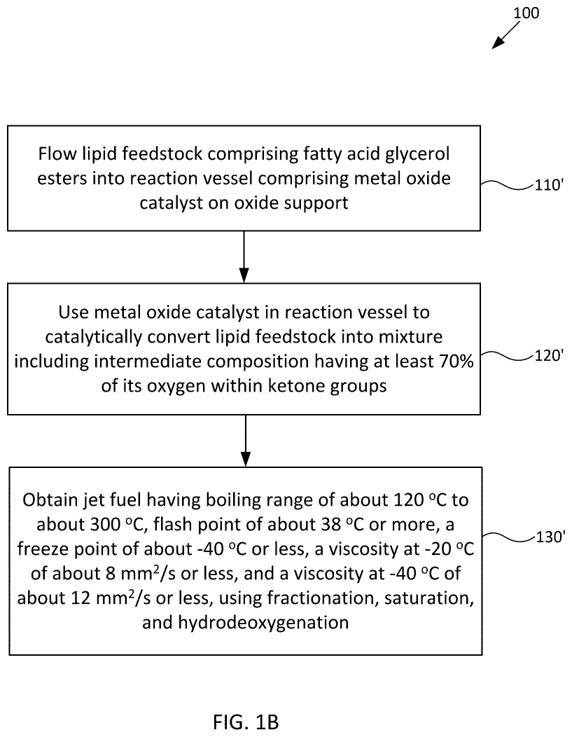

FIG. 1A illustrates an example flow of operations in a method for converting a lipid feedstock to a jet fuel blend. Method 100 illustrated in FIG. 1A may include flowing the lipid feedstock including fatty acid glycerol esters into a reaction vessel including a metal oxide catalyst on an oxide support (operation 110). Nonlimiting examples of lipid feedstocks are provided further above. The lipid feedstock may be flowed over any suitable metal oxide catalyst. In some examples, the metal oxide catalyst includes at least one metal selected from the group consisting of Na, K, Mg, Ca, Sr, and a rare earth metal. Illustratively, the metal oxide catalyst may include at least one metal selected from the group consisting of Na, K, Ca, and Mg. In some examples, the metal of the metal oxide catalyst may be an alkali metal such as lithium, sodium, or potassium. In some examples, the metal of the metal oxide catalyst may be an alkaline earth metal such as magnesium, strontium, or calcium.

In one nonlimiting example, the metal oxide catalyst may include calcium oxide, and in some examples may consist essentially of calcium oxide, or may consist of calcium oxide. The calcium within the calcium oxide catalyst may be in oxidation state 2 (as in CaO), but it may be in any suitable chemical form and is not limited to exclusively CaO. Additionally, the chemistry of the calcium oxide catalyst may change over time and/or with exposure to the lipid feedstock. For example, the calcium oxide catalyst initially may be in the form of CaO, CaO(OH), or Ca(OH)₂, or a mixture thereof. In operation, the calcium may be in the form of a mixture of any such compounds and/or in the form of carbonate or carboxylate. Additionally, or alternatively, the calcium may become partially embedded in the oxide support as aluminate, e.g., oxy-aluminate and/or hydroxy-aluminates. The metal oxide catalyst may be supported on any suitable oxide support, such as alumina. In some examples, the lipid feedstock is flowed over substantially no other solid-state materials besides the metal oxide catalyst (e.g., calcium oxide catalyst or other alkaline earth metal oxide catalyst) on the oxide support (e.g., alumina).

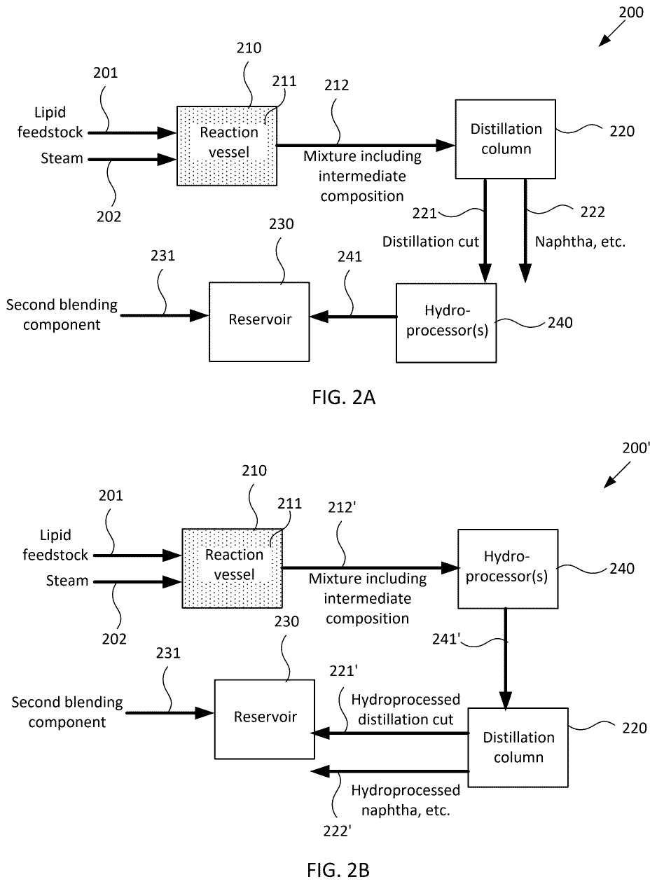

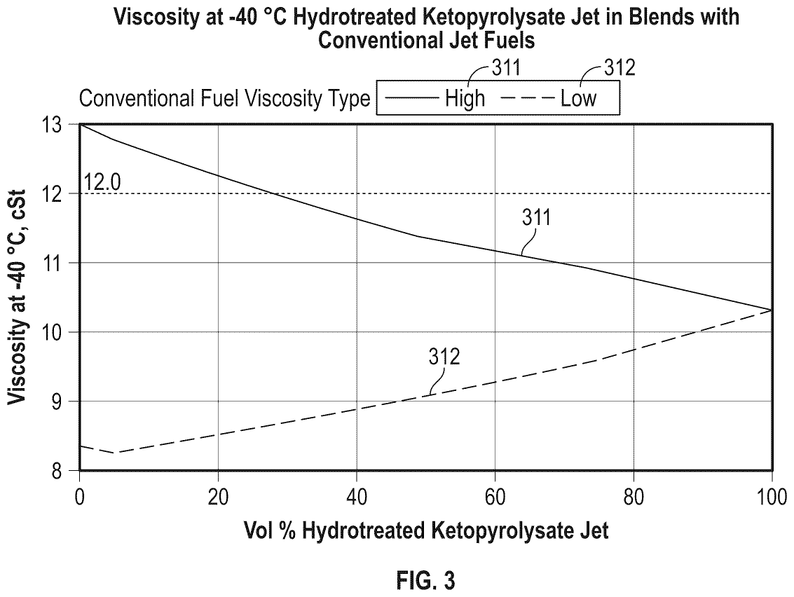

The lipid feedstock may be flowed over the metal oxide catalyst in any suitable reaction vessel(s). Although the oxide support may not specifically be mentioned in all cases, it will be understood that the metal oxide catalyst is supported by the oxide support. FIG. 2A schematically illustrates an example system for converting a lipid feedstock to a jet fuel. In the nonlimiting example illustrated in FIG. 2A, system 200 may include reaction vessel 210 in which metal oxide catalyst 211 is disposed. Piping 201 may be coupled to a first inlet of reaction vessel 210 such that lipid feedstock may be flowed into reaction vessel 210 and across metal oxide catalyst 211. Piping 202 may be coupled to a second inlet of reaction vessel 210 such that steam may be flowed into reaction vessel 210 and across metal oxide catalyst 211 together with the lipid feedstock.

In some examples, the metal oxide catalyst 211 is in a fixed bed over which the lipid feedstock is flowed, the metal oxide catalyst and the feedstock may be brought into contact with one another in any suitable manner. In other examples, the metal oxide catalyst 211 instead may be in a fluid bed, or in a moving bed. It will be appreciated that the metal oxide catalyst on the oxide support may have any suitable configuration for use in the particular reaction vessel 210. In some examples, the metal oxide catalyst on the oxide support includes particles with sizes in the range of about 0.01 mm to about 5 mm. In nonlimiting examples in which a fixed bed reaction is used, the metal oxide catalyst on the oxide support may include (or in some cases may consist essentially of) particles with sizes in the range of about 1 mm to about 5 mm. In nonlimiting examples in which a fluid bed reaction is used, the metal oxide catalyst on the oxide support may include (or in some cases may consist essentially of) particles with sizes in the range of about 0.05 mm to about 0.2 mm. In nonlimiting examples in which a moving bed reaction is used, the metal oxide catalyst on the oxide support may include (or in some cases may consist essentially of) particles with sizes in the range of about 0.05 mm to about 0.2 mm.

The metal oxide catalyst on the oxide support additionally, or alternatively, may have any suitable combination of properties, e.g., bulk density, particle density, packed density, pore volume, large pore content, average pore diameter, and/or surface area. Illustratively, the metal oxide catalyst may have one or more of the following properties, or any suitable combination of two or more of the following properties: a bulk density in the range of about 0.78 kg/l to about 0.86 kg/l; a particle density in the range of about 1.2 kg/l to about 1.4 kg/l; a packed density in the range of about 0.8 g/cc to about 1.0 g/cc; a pore volume in the range of about 0.42 to about 0.48 cc/g; a large pore content (pores>1000 Å) of about 0.30 cc/g to about 0.38 cc/g; an average pore diameter (D50) of about 100 Å to about 200 Å; and/or a surface area of about 50 m²/g to about 150 m²/g. Additionally, or alternatively, the metal oxide catalyst may have one or more of the following properties, or any suitable combination of two or more of the following properties: a bulk density in the range of about 0.80 kg/l to about 0.84 kg/l; a particle density in the range of about 1.1 kg/l to about 1.3 kg/l; a packed density in the range of about 0.85 g/cc to about 0.95 g/cc; a pore volume in the range of about 0.44 to about 0.46 cc/g; a large pore content (pores>1000 Å) of about 0.33 cc/g to about 0.36 cc/g; an average pore diameter (D50) of about 130 Å to about 160 Å; and/or a surface area of about 80 m²/g to about 120 m²/g.

Referring again to FIG. 1A, method 100 further may include using the metal oxide catalyst in the reaction vessel to catalytically convert the lipid feedstock into a mixture which includes an intermediate composition having at least 70% of its oxygen within ketone groups (operation 120). The lipid feedstock may be reacted with the metal oxide catalyst under any suitable combination of reaction conditions to generate the mixture. In various examples, the catalytic conversion may be performed at a temperature of about 400° C. to about 700° C., illustratively about 425° C. to about 600° C., e.g., about 450° C. to about 550° C., e.g., about 475° C. to about 500° C. Additionally, in some examples, the catalytic conversion may be performed at a pressure in the range of about 0.01 MPa to about 10 MPa, illustratively about 0.1 to about 5 MPa, e.g., about 0.1 to about 1 MPa. Additionally, in some examples, the catalytic conversion may be performed at a liquid hourly space velocity (LHSV) in the range of about 0.1 h⁻¹ to about 10 h⁻¹, illustratively about 0.2 h⁻¹ to about 5 h⁻¹, or about 0.3 h⁻¹ to about 3 h⁻¹, or about 0.5 h⁻¹ to about 1.5 h⁻¹. LHSV may be calculated as the volume of lipid feedstock per volume of catalyst per hour.

In some examples, the catalytic conversion of the lipid feedstock to the mixture uses steam as an additional input to the reaction vessel, e.g., via piping 202 coupled to a second inlet of reaction vessel 210 illustrated in FIG. 2A. The steam may inhibit cracking and coke formation. In some examples, the steam is provided in an amount of about 0 wt % to about 50 wt %, and its use is optional. Some examples use substantially only steam and the lipid feedstock as inputs to the reaction vessel 210 for reactions which are catalyzed by the metal oxide catalyst on the oxide support. That is, hydrogen may not be separately input to reaction vessel 210. Additionally, the steam may not be a reactant in the reactions between the lipid feedstock and the metal oxide catalyst on the oxide support, e.g., may not be a source of hydrogen for such reactions. In some examples, the steam is omitted.

The reaction(s) performed using the metal oxide catalyst may reduce the amount of oxygen in the lipid feedstock. For example, the intermediate composition may include less than about 70 wt % of an amount of oxygen in the lipid feedstock. Additionally, the reaction(s) performed using the metal oxide catalyst may modify the location(s) of oxygen within the molecules being reacted. For example, at least about 70 wt %, or at least about 80 wt %, of the oxygen in the liquid portion of the mixture may be within ketone groups. In comparison, in some examples, the lipid feedstock substantially may not include any ketone groups.

As provided herein, in addition to converting the lipid feedstock to the mixture, the metal oxide catalyst on the oxide support also may be used to remove impurities from the renewable feedstock during operation 120, for example without the use of a separate catalyst. Indeed, the catalytic conversion described with reference to FIGS. 1A and 2A may remove multiple contaminants. In some examples, the intermediate composition lacks a detectable amount of metal. In some examples, the intermediate composition lacks a detectable amount of phosphorous. In some examples, intermediate composition lacks a detectable amount of chlorine. The amount (if any) of metal, phosphorous, and/or certain other contaminants may be measured in any suitable manner, such as inductively coupled plasma-mass spectrometry (ICP). In some examples, an organic chloride contaminant level can be determined by X-ray Fluorescence Spectroscopy, e.g., ASTM D7536-09, Standard Test Method for Chlorine in Aromatics by Monochromatic Wavelength Dispersive X-ray Fluorescence Spectrometry. In other examples, chlorine content may be determined using combustion ion chromatography (CIC), a technique in which a sample is burned in an oxygen-containing gas flow, the gas generated (including halogen ions) is absorbed by a solution, and then the halogen content of the solution is quantitatively analyzed using ion chromatography. Additionally, or alternatively, in some examples, chlorine content may be determined using X-ray fluorescence to determine chloride content with a detection limit of about 1 ppm.

When it is described herein that a composition “lacks a detectable amount” of an element, it means that the amount of that element in the composition is approximately at or below than the measurement threshold of the respective instrument being used to measure that element. Of course, different instruments may have different measurement thresholds than one another. In some examples, the instrument has a measurement threshold of about 5 ppm, and the intermediate composition has a concentration of less than about 5 ppm of metal, phosphorous, and/or chlorine. In some examples, the instrument has a measurement threshold of about 1 ppm, and the intermediate composition has a concentration of less than about 1 ppm of metal, phosphorous, and/or chlorine. In other examples, the instrument has a measurement threshold of about 0.5 ppm, and the intermediate composition has a concentration of less than about 0.5 ppm of metal, phosphorous, and/or chlorine. In still other examples, the instrument has a measurement threshold of about 0.1 ppm, and the intermediate composition has a concentration of less than about 0.1 ppm of metal, phosphorous, and/or chlorine.

Illustratively, in the nonlimiting example illustrated in FIG. 2A, system 200 may include piping 212 coupled to an outlet of reaction vessel 210 such that the mixture including the intermediate composition, which is generated by reaction of the lipid feedstock with the metal oxide catalyst 211 within vessel 210, may be flowed out of reaction vessel 210. The metal oxide catalyst 211 may be regenerated at any suitable time, and in any suitable manner. For example, in nonlimiting configurations in which the metal oxide catalyst is in a fixed bed, the lipid feedstock inlet may be turned off, and air may be provided to the reaction vessel 210 to stimulate a combustion process therein which burns coke from the metal oxide catalyst 211.

Referring again to FIG. 1A, method 100 may include obtaining a synthetic blending component having a boiling range of about 120° C. to about 300° C. using fractionation, saturation, and hydrodeoxygenation (operation 130). The sub-operations of operation 130 may be performed in any suitable combination and order. Illustratively, operation 130 may include using fractionation to obtain a distillation cut of the mixture and then saturating and deoxygenating the cut. For example, as illustrated in FIG. 2A, piping 212 may directly or indirectly couple reaction vessel 210 to distillation column 220 which is configured to fractionate the mixture including the intermediate composition, to obtain the cut. Distillation column 220 may be coupled to hydroprocessor(s) 240 via piping 221, to transport the cut to the hydroprocessor(s). Hydroprocessor(s) 240 may be configured to saturate and hydrodeoxygenate the cut. The hydroprocessed cut may be transported to reservoir 230 using piping 241, and may be stored in reservoir 230 and/or may be transported for use as a fuel or in a fuel blend, e.g., in a manner such as described herein. Alternatively, in system 200′ illustrated in FIG. 2B, piping 212′ may directly or indirectly couple reaction vessel 210 to hydroprocessor(s) 240 configured to saturate and hydrodeoxygenate the mixture including the intermediate composition. Distillation column 220 may be coupled to hydroprocessor(s) 240 via piping 241′, to transport the cut to the distillation column 220. Distillation column 220 is configured to fractionate the hydroprocessed mixture, including the hydroprocessed intermediate composition, to obtain the cut. The hydroprocessed cut may be transported to reservoir 230 using piping 221′, and may be stored in reservoir 230 and/or may be transported for use as a fuel or in a fuel blend, e.g., in a manner such as described herein.

Whether the hydroprocessed distillation cut obtained in operation 130 is used directly as a fuel or is blended with a fuel to create a fuel blend, the distillation range of the hydroprocessed cut may be selected to provide suitable properties of the component, e.g., synthetic blending component, and/or final product. In the nonlimiting example of operation 130 shown in FIG. 1A, the hydroprocessed cut has a boiling range of about 120° C. to about 300° C. However, in other examples a different boiling range may be selected.

Indeed, hydroprocessor(s) 240 and distillation column 220 further may be used to generate other cuts and/or other hydroprocessed cuts in boiling ranges other than the jet range, in addition to the hydroprocessed cut which is used as jet fuel or in a jet fuel blend. Illustratively, a product with a higher initial boiling point (IBP, lower end of stated range) is expected to have a higher flash point, while a product with a lower end point (EP, higher end of stated range) is expected to have better cold flow properties.

In various nonlimiting examples of the system illustrated in FIG. 2A, distillation column 220 may generate one or more additional distillation cut(s) which are output using piping 222 rather than being transported to hydroprocessor(s) 240. The additional distillation cut(s) may be from about 200° F. to about 750° F., e.g., from about 300° F. to about 680° F., or from about 250° F. to about 600° F., e.g., from about 300° F. to about 600° F., e.g., from about 300° F. to about 550° F., or from about 200° F. to about 550° F. Illustratively, a distillation cut in the range of about 300° F. to about 680° F. suitably may be used as a diesel #2 fuel blend component or as a direct diesel #2 fuel. A distillation cut in the range of about 250° F. to about 600° F. suitably may be used as a diesel #1 fuel blend component or as a direct diesel #1 fuel, or in some examples may be used as a diesel #2 fuel blend component or as a direct diesel #2 fuel. A distillation cut in the range of about 300° F. to about 600° F. suitably may be used as either a diesel #1 or diesel #2 fuel blend component or as a direct diesel #1 or diesel #2 fuel. A distillation cut in the range of about 300° F. to about 550° F. suitably may be used as a diesel #1 fuel blend component or as a direct diesel #1 fuel; or suitably may be used as a diesel #2 fuel blend component; or may be hydrotreated to remove oxygen and unsaturation and suitably used as a jet fuel component. A distillation cut in the range of about 200° F. to about 550° F., with a sufficiently high flash point (38° C.) suitably may be used as a diesel #1 fuel blend component or a direct diesel #1 fuel. In some examples, operation 130 may include removing naphtha and other components from the mixture to form the portion of the mixture that is used in the jet fuel or jet fuel blend.

In various nonlimiting examples of the system illustrated in FIG. 2B, distillation column 220 may generate one or more additional hydroprocessed distillation cut(s) of the hydroprocessed mixture from hydroprocessor(s) 240, and may output such cut(s) using piping 222′. The additional hydroprocessed distillation cut(s) may be from about 200° F. to about 750° F., e.g., from about 300° F. to about 680° F., or from about 250° F. to about 600° F., e.g., from about 300° F. to about 600° F., e.g., from about 300° F. to about 550° F., or from about 200° F. to about 550° F. Illustratively, a hydroprocessed distillation cut in the range of about 300° F. to about 680° F. suitably may be used as a diesel #2 fuel blend component or as a direct diesel #2 fuel. A hydroprocessed distillation cut in the range of about 250° F. to about 600° F. suitably may be used as a diesel #1 fuel blend component or as a direct diesel #1 fuel, or in some examples may be used as a diesel #2 fuel blend component or as a direct diesel #2 fuel. A hydroprocessed distillation cut in the range of about 300° F. to about 600° F. suitably may be used as either a diesel #1 or diesel #2 fuel blend component or as a direct diesel #1 or diesel #2 fuel. A hydroprocessed distillation cut in the range of about 300° F. to about 550° F. suitably may be used as a diesel #1 fuel blend component or as a direct diesel #1 fuel; or suitably may be used as a diesel #2 fuel blend component; or may be hydrotreated to remove oxygen and unsaturation and suitably used as a jet fuel component. A hydroprocessed distillation cut in the range of about 200° F. to about 550° F., with a sufficiently high flash point (38° C.) suitably may be used as a diesel #1 fuel blend component or a direct diesel #1 fuel. In some examples, operation 130 may include removing naphtha and other components from the hydroprocessed mixture to form the portion of the hydroprocessed mixture that is used in the jet fuel or jet fuel blend.

In nonlimiting examples such as illustrated in FIGS. 2A-2B, system 200 or 200′ may include reservoir 230 which is configured to receive the hydroprocessed cut generated using operation 130. The hydroprocessed cut may be blended with a fuel to create a jet fuel blend. For example, referring again to FIG. 1A, method 100 may include blending the synthetic blending component with a second blending component to create a jet fuel blend having a flash point of about 38° C. or more, a freeze point of about −40° C. or less, a viscosity at −20° C. of about 8 mm²/s or less, and a viscosity at −40° C. of about 12 mm²/s or less (operation 140). For example, as illustrated in FIG. 2A, piping 221 may be used to flow the distillation cut into reservoir 230 where the distillation cut is blended with a second blending component which is flowed into reservoir 230 via piping 231, to create the jet fuel blend. Reservoir 230 may be located in a fixed position or may be portable, e.g., may located on a tanker truck or tanker ship to transport the jet fuel blend to another location for further processing which is non-catalytic and/or for use as a fuel.

The jet fuel blend obtained using method 100 and/or systems 200 or 200′ may meet some or all of the requirements in Table 1 of the ASTM D7566 standard, set forth below and described in, e.g., ASTM D7566-24d, “Standard Specification for Aviation Turbine Fuel Containing Synthesized Hydrocarbons,” published by ASTM International (2024), the entire contents of which are incorporated by reference herein. Moreover, even if the jet fuel blend does not meet each of these requirements, the jet fuel blend nonetheless may have suitable properties to be used as a drop-in replacement for jet fuel meeting the Jet A and/or Jet A-1 specifications.

ASTM D7566, Table 1. Detailed requirements of aviation
turbine fuels containing synthesized hydrocarbons.

| Property | Test Method | Jet A or Jet A-1 |
|---|---|---|
| COMPOSITION | | |
| Acidity, total mg KOH/g, max | ASTM D3242/IP 354 | 0.10 |
| Aromatics: one of the | | |
| following requirements shall | | |
| be met: | | |
| (a) Aromatics, volume percent | ASTM D1319 or IP 156, | 8-25 |
| | ASTM D8267, ASTM D8305 | |
| (b) Aromatics, volume percent | ASTM D6379/IP 436 | 8.4-26.5 |
| Sulfur, mercaptan, mass | ASTM D3227/IP 342 | 0.003 |
| percent, max | | |
| Sulfur, total mass percent, | ASTM D1266, ASTM D2622, | 0.30 |
| max | ASTM D4294, ASTM D5453, | |
| | IP 336 | |
| VOLATILITY | | |
| Distillation temperature, ° C.: | ASTM D86, ASTM D2887/IP | |
| | 406, ASTM D7344, ASTM | |
| | D7345, IP 123 | |
| 10% recovered, temperature | | 205 |
| (T10), max | | |
| 50% recovered, temperature | | Report |
| (T50), max | | |
| 90% recovered, temperature | | Report |
| (T90), max | | |
| Final boiling point, | | 300 |
| temperature, max | | |
| T50 minus T10, min | | 15 |
| T90 minus T10, min | | 40 |
| Distillation residue, percent, | | 1.5 |
| max | | |
| Distillation loss, percent, max | | 1.5 |
| Flash point, ° C., min | ASTM D56, ASTM D3828, | 38 |
| | ASTM D7236, IP 170, IP 523, | |
| | IP 534 | |
| Density at 15° C., kg/m³ | ASTM D1298, IP 160, ASTM | 775 to 840 |
| | D4052, IP 365 | |
| FLUIDITY | | |
| Freezing point, ° C., max | ASTM D5972/IP 435, ASTM | −40, Jet A |
| | D7153/IP 529, ASTM D7154 | −47, Jet A-1 |
| | or IP 528, ASTM D2386/IP | |
| | 16 | |
| VISCOSITY | | |
| One of the following | | |
| requirements shall be met | | |
| (whichever is applicable): | | |
| (1) The following requirement | ASTM D445 or IP 71, Section | 8.0 |
| shall be met for semi-synthetic | 1, ASTM D7042, ASTM | |
| jet fuel containing Annex A1 | D7945 | |
| or Annex A4 synthesized | | |
| components blended in | | |
| accordance with 6.1.1 or | | |
| 6.1.4, respectively: Viscosity −20° C., | | |
| mm²/s, max, or | | |
| (2) The following requirement | ASTM D445 or IP 71, Section | 8.0 |
| shall be met for semi-synthetic | 1, ASTM D7042, ASTM | |
| jet fuel containing Annex A5 | D7945 | |
| synthetic blend components | | |
| blended at less than or equal | | |
| to 30% by volume in | | |
| accordance with 6.1.5: | | |
| Viscosity −20° C., mm²/s, max, | | |
| or | | |
| (3) The following | ASTM D445 or IP 71, Section | 8.0 (Viscosity −20° C., mm²/s, |
| requirements shall be met for | 1, ASTM D7042, ASTM | max) and |
| semi-synthetic jet fuel | D7945 | 12.0 (Viscosity −40° C., mm²/s, |
| containing Annex A2, or | | max) |
| Annex A3, or Annex A6, or | | |
| Annex A7, or Annex A8 | | |
| synthetic blend components | | |
| blended in accordance with | | |
| 6.1.2, or 6.1.3, or 6.1.6, or | | |
| 6.1.7, or 6.1.8, respectively: | | |
| Viscosity −20° C., mm²/s, max, | | |
| and | | |
| Viscosity −40° C., mm²/s, max, | | |
| or | | |
| (4) The following | ASTM D445 or IP 71, Section | 8.0 (Viscosity −20° C., mm²/s, |
| requirements shall be met for | 1, ASTM D7042, ASTM | max) and |
| semi-synthetic jet fuel | D7945 | 12.0 (Viscosity −40° C., mm²/s, |
| containing Annex A5 | | max) |
| synthetic blend components | | |
| blended at greater than 30% | | |
| by volume in accordance with | | |
| 6.1.5: Viscosity −20° C., | | |
| mm²/s, max, and | | |
| Viscosity −40° C., mm²/s, max | | |
| LUBRICITY | | |
| Lubricity mm, max | ASTM D5001 | 0.85 |
| COMBUSTION | | |
| Net heat of combustion, | ASTM D4529, ASTM D3338, | 42.8 |
| MJ/kg, min | ASTM D4809 or IP 12 | |
| One of the following | | |
| requirements shall be met: | | |
| (1) Smoke point, mm, min or | ASTM D1322/IP 598 | 25.0 |
| (2) Smoke point, mm, min and | ASTM D1322/IP 598, ASTM | 18.0 (Smoke point, mm, min) |
| naphthalenes, volume, | D1840 or ASTM D8305 | and 3.0 (naphthalenes, |
| percent, max | | volume, percent, max) |
| CORROSION | | |
| Copper strip, 2 h at 100° C., | ASTM D130 or IP 154 | No. 1 |
| max | | |
| THERMAL STABILITY | | |
| 2.5 h at control temperature of | | |
| 260° C., min | | |
| Filter pressure drop, mm Hg, | ASTM D3241/IP 323 | 25 |
| max | | |
| Tube rating: One of the | | |
| following requirements shall | | |
| be met: | | |
| (1) Annex A1 VTR, VTR | | 3, no peacock or abnormal |
| color code, less than | | color deposits |
| (2) Annex A2 ITR or Annex 3 | | 85 |
| ETR, or Annex A4 MWETR, | | |
| nm avg over area of 2.5 mm², | | |
| max | | |
| CONTAMINANTS | | |
| Existent gum, mg/100 mL, | ASTM D381, IP 540 | 7 |
| max | | |
| Microseparometer, rating, | ASTM D3948 | 85 (without electrical |
| min, without electrical | | conductivity additive), 70 |
| conductivity additive, with | | (with electrical conductivity |
| electrical conductivity | | additive) |
| additive | | |
| ADDITIVES | | |
| Electrical conductivity, pS/m | ASTM D2624/IP 274 | If electrical conductivity |
| | | additive is used, the |
| | | conductivity shall not exceed |
| | | 600 pS/m at the point of use |
| | | of the fuel. When electrical |
| | | conductivity additive is |
| | | specified by the purchaser, the |
| | | conductivity shall be 50 pS/m |
| | | to 600 pS/m under the |
| | | conditions at point of delivery |
| | | (1 pS/m = 1 × 10⁻¹² Ω⁻1m⁻¹) |

In the above table, “Report” means there are no limits for this property in the ASTM D7566 standard, but a test result should be provided because it provides useful information, and because there potentially may be a contractual limit.

Some examples of the jet fuel blend provided herein may include a synthetic blending component having a generally normally distributed carbon number distribution ranging from C7-C18 with about 20-30 mass 0% n-paraffins, about 25-35 mass 0% i-paraffins, about 35-45 mass % cycloparaffins, and about 0-10% mass aromatics; and a second blending component. The jet fuel blend may have a flash point of about 38° C. or more, a freeze point of about −40° C. or less, a viscosity at −20° C. of about 8 mm²/s or less, and a viscosity at −40° C. of about 12 mm²/s or less. In examples in which the jet fuel blend's freeze point is less than about −40° C., the blend may meet Jet A specifications. In examples in which the jet fuel blend's freeze point is less than about −47° C., the blend may meet Jet A-1 specifications. Nonlimiting examples of the present synthetic blending component are described with reference to FIGS. 1A and 2A-2B and the working examples. By “generally normally distributed,” it is meant that the distribution of carbon number within the synthetic blending component approximately follows a Gaussian curve. Illustratively, in the nonlimiting example described below in the Working Examples, a synthetic blending component prepared using the present systems and methods has a generally normal distribution of carbon number which includes an apex at C11, and generally falls from there although there is a slight plateau with increasing carbon number before the distribution tapers down.

Additionally, or alternatively, the synthetic blending component may be made using operations including flowing a lipid feedstock including fatty acid glycerol esters into a reaction vessel including a metal oxide catalyst on an oxide support. The operations further may include using the metal oxide catalyst in the reaction vessel to catalytically convert the lipid feedstock into a mixture including an intermediate composition having at least 70% of its oxygen within ketone groups. The operations further may include obtaining a synthetic blending component having a boiling range of about 120° C. to about 300° C. using operations including either (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture. The jet fuel blend further may include a second blending component. The jet fuel blend may have a flash point of about 38° C. or more, a freeze point of about −40° C. or less, a viscosity at −20° C. of about 8 mm²/s or less, and a viscosity at −40° C. of about 12 mm²/s or less. In examples in which the jet fuel blend's freeze point is less than about −40° C., the blend may meet Jet A specifications. In examples in which the jet fuel blend's freeze point is less than about −47° C., the blend may meet Jet A-1 specifications. Nonlimiting examples of the present synthetic blending component are described with reference to FIGS. 1A and 2A-2B and the working examples.

The synthetic blending component and the second blending component may be blended together in any suitable amounts to create the jet fuel blend. Illustratively, in some examples of the above jet fuel blend(s), about 1-99 vol % of the jet fuel blend is the synthetic blending component.

In some examples of the above jet fuel blend(s), about 1-50 vol % of the jet fuel blend is the synthetic blending component. In some examples, the second blending component includes a conventional blending component. By “conventional blending component” it is meant hydrocarbons that are derived from the following conventional sources: crude oil, natural gas condensates, heavy oil, shale oil, and oil sands, or Jet A or Jet A-1 fuel certified to specification D1655. Among the various jet fuel blends that ASTM D7566 permits, some blends can include up to 50 vol % of a synthetic blending component defined in Annex A2 of that standard. Annex A2 defines synthesized paraffinic kerosene produced from hydroprocessed esters and fatty acids for use as a synthetic blending component in aviation turbine fuels for use in civil aircraft and engines. According to Annex A2, the hydroprocessed synthesized paraffinic kerosene must be wholly derived from paraffins derived from hydrogenation and deoxygenation of fatty acid esters and free fatty acids. Because the present synthetic blending component is not made according to Annex A2, a jet fuel blend of which about 1-50 vol % is the synthetic blending component and the balance is the conventional blending component does not technically satisfy Table 1 of the ASTM D7566 standard. Nonetheless, the jet fuel blend may meet the rest of the Table 1 specifications of the ASTM D7566 standard, other than the requirement that the synthetic blending component is specified in one of Annexes A1-A8 (e.g., Annex A2).

Additionally, among the various jet fuel blends that ASTM D7566 permits, some blends can include up to 50 vol % of a synthetic blending component defined in Annex A6 of that standard. Annex A6 defines Catalytic Hydrothermolysis Jet (CHJ) as synthesized kerosene containing aromatic compounds produced from hydrothermally processed fatty acid esters and fatty acids for use as a synthetic blending component in aviation turbine fuels for use in civil aircraft and engines. According to Annex A6, the synthetic blending component shall be comprised of hydroprocessed synthesized kerosene containing aromatics that is wholly derived from hydrothermal conversion of fatty acid esters and free fatty acids. Because the present synthetic blending component is not made according to Annex A6, a jet fuel blend of which about 1-50 vol % is the synthetic blending component and the balance is the conventional blending component does not technically satisfy Table 1 of the ASTM D7566 standard. Nonetheless, jet fuel blend may meet the rest of the Table 1 specifications of the ASTM D7566 standard, other than the requirement that the synthetic blending component is specified in one of Annexes A1-A8 (e.g., Annex A6).

As recognized by the present inventors, although ASTM D7566 specifies that up to 50 vol % of the synthetic blending component must be blended with a conventional blending component, suitable jet fuel blends nonetheless may be obtained using one or more synthetic blending components in place of the conventional blending component. Such a jet fuel blend may meet the Table 1 specifications of the ASTM D7566 standard, other than the requirements that the synthetic blending component is specified in one of Annexes A1-A8 and that the second blending component be a conventional blending component.

In still other examples of the above jet fuel blend(s), about 50-99 vol % of the jet fuel blend is the synthetic blending component. As recognized by the present inventors, although ASTM D7566 specifies that up to 50 vol % of the synthetic blending component must be blended with a conventional blending component, suitable jet fuel blends nonetheless may be obtained using a greater amount of the present blending component, and/or using one or more synthetic blending components in place of the conventional blending component. Illustratively, about 50-99 vol % of the jet fuel blend is the synthetic blending component, the second blending component includes a conventional blending component, and the jet fuel blend meets the Table 1 specifications of the ASTM D7566 standard, other than the requirements that the synthetic blending component is specified in one of Annexes A1-A8 and that no more than 50 vol % of the jet fuel blend be the synthetic blending component. Or, for example, about 50-99 vol % of the jet fuel blend is the synthetic blending component, the second blending component includes a second synthetic blending component, and the jet fuel blend meets the Table 1 specifications of the ASTM D7566 standard, other than the requirements that the synthetic blending component is specified in one of Annexes A1-A8, that no more than 50 vol % of the jet fuel blend be the synthetic blending component, and that the second blending component be a conventional blending component.

Certain blending components may find particular utility in cases where the present synthetic blending component contains an insufficient amount of aromatics to meet the Table 1 specifications of the ASTM D7566 standard. In such examples, a second blending component may be selected and used that contains a sufficient amount of aromatics that the jet fuel blend includes about 8-25 vol % aromatics, and thus meets this and the other Table 1 specifications of the ASTM D7566 standard, other the requirement that the second blending component be a conventional blending component. Illustratively, the second blending component may include hydrotreated jet boiling range material from lipids processed through an FCC unit; or may include ASTM D7566 Annex A6 synthetic blending component; and/or may include ASTM D7566 Annex A8 synthetic blending component. Each of such second synthetic blending components is expected to have a sufficient amount of aromatics to compensate for a relatively low amount of aromatics in the present synthetic blending component. Moreover, in examples in which the second synthetic blending component(s) are renewable, the jet fuel blend may constitute a 100% renewable drop-in SAF (that is, the jet fuel blend may consist essentially of sustainable aviation fuel).

In still other examples of the above jet fuel blend(s), the jet fuel blend includes about 1-8 vol % aromatics. While such range falls outside of the range of aromatics permitted by Table 1 of the ASTM D7566 standard, the jet fuel blend nonetheless may have suitable properties to be used as a drop-in replacement for jet fuel meeting the Jet A and/or Jet A-1 specifications. For example, the jet fuel blend may contain sufficient cycloparaffin content to maintain seal swell, even though the amount of aromatics is relatively low.

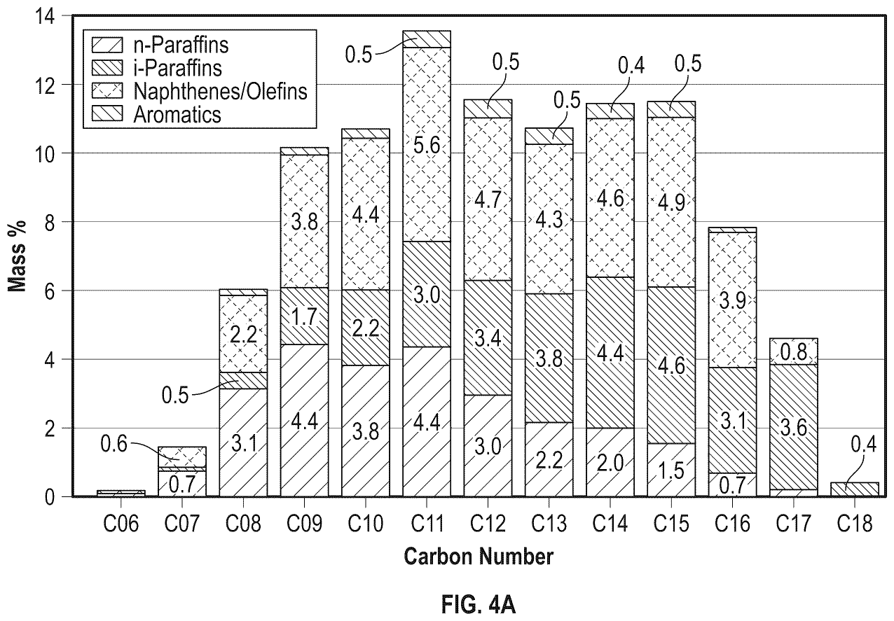

Any suitable second blending component(s) may be blended with the present synthetic blending component in any suitable amount to obtain a jet fuel blend that is usable as a drop-in replacement for Jet A and/or Jet A-1. For example, while ASTM D7566 requires a viscosity maximum at −40° C. of 12 mm²/s (units alternatively expressed as cSt), viscosity is not a requirement of conventional jet fuels and it has been shown that some conventional jet fuels do not meet this requirement prior to blending with synthetic blending components. In many cases, this means that the maximum blend concentration of previously known synthetic blending components with a conventional jet fuel is 0 vol %, since many such synthetic blending components also exceed the 12 mm²/s at −40° C. maximum viscosity permitted by ASTM D7566. One of the benefits of the present synthetic blending component is that it has a viscosity at −40° C. which is less than the 12 mm²/s maximum. Accordingly, the present synthetic blending component may be blended in a suitable amount with a second blending component that has a viscosity at −40° C. of more than 12 mm²/s, to obtain a jet fuel blend that meets the maximum viscosity permitted by ASTM D7566. For example, FIG. 3 is a plot of the viscosity at −40° C. of blends of the present synthetic blending component with high viscosity conventional jet fuel (trace 311), or with low viscosity conventional jet fuel (trace 312). As may be understood from FIG. 3, low viscosity conventional jet fuels (which have a viscosity at −40° C. of less than the 12 mm²/s) may be blended in any amount with the present synthetic blending component (which may be referred to as hydrotreated ketopyrolysate jet) and still meet the maximum 12 mm²/s viscosity at −40° C. permitted by ASTM D7566. For the high viscosity conventional jet fuels (here assumed to have a viscosity at −40° C. of 13 mm²/s), jet fuel blends which contain at least 30 vol % of the present synthetic blending component meet the maximum 12 mm²/s viscosity at −40° C. permitted by ASTM D7566.

In some examples of the above jet fuel blend(s), the jet fuel blend consists essentially of the synthetic blending component and the second blending component. In other examples, the jet fuel blend contains additional components.

While the present synthetic blending component may find particular utility in creating jet fuel blends, the component alternatively may be used itself as a jet fuel, that is, without blending the component with a second blending component in a manner such as described with reference to FIGS. 1A, 2A, 2B, and 3.

For example, FIG. 1B illustrates an example flow of operations in method 100′ for converting a lipid feedstock to a jet fuel. Similarly as described with reference to method 100, method 100′ may include flowing a lipid feedstock including fatty acid glycerol esters into a reaction vessel including a metal oxide catalyst on an oxide support (operation 110′). Reaction vessel 210 described with reference to FIGS. 2A-2B may be used in such a manner. Additionally, similarly as described with reference to method 100, method 100′ may include using the metal oxide catalyst in the reaction vessel to catalytically convert the lipid feedstock into a mixture including an intermediate composition having at least 70% of its oxygen within ketone groups (operation 120′). Reaction vessel 210 described with reference to FIGS. 2A-2B may be used in such a manner. Method 100′ also may include obtaining a jet fuel having a boiling range of about 120° C. to about 300° C., a flash point of about 38° C. or more, a freeze point of about −40° C. or less, a viscosity at −20° C. of about 8 mm²/s or less, and a viscosity at −40° C. of about 12 mm²/s or less (operation 130′). Similarly as described with reference to operation 130, operation 130′ may include using operations including either (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture. For example, distillation column 220 and hydroprocessor(S) 240 described with reference to FIGS. 2A-2B may be used in such a manner. However, while method 100 includes blending the hydroprocessed cut of operation 130 with a second blending component, method 100′ instead uses the hydroprocessed cut of operation 130 as a finished jet fuel.

It will be appreciated that the operations described with reference to methods 100 and 100′ need not necessarily be performed by a single entity. For example, in method 100, a first entity may perform operations 110 and 120, a second entity may perform operations 130, and either the second entity or a third entity may perform operation 140. In some examples, an alternative method 100 provided herein includes receiving the output of operations 110 and 120, and performing operations 130 and 140 on that output to generate a jet fuel blend. Or, for example, in method 100′, a first entity may perform operations 110 and 120, and a second entity may perform operations 130. In some examples, an alternative method 100′ provided herein includes receiving the output of operations 110 and 120, and performing operation 130 on that output to generate a jet fuel.

In some examples, the jet fuel obtained using method 100′ and/or systems 200 or 200′ meets the Table 1 specifications of the ASTM D1655 standard, set forth below and described in, e.g., ASTM D1655-24b, “Standard Specification for Aviation Turbine Fuels,” published by ASTM International (2024), the entire contents of which are incorporated by reference herein. Moreover, even if the jet fuel does not meet each of these requirements, the jet fuel nonetheless may have suitable properties to be used as a drop-in replacement for jet fuel meeting the Jet A and/or Jet A-1 specifications. Note that while ASTM D7566 requires 8-25 vol % of aromatics, D-1655 does not have such requirement. As such, even if the present jet fuels contain less than 8 vol 00 aromatics and thus do not meet ASTM D7566, they may still meet the Table 1 requirements of D-1655.

ASTM D1655, Table 1. Detailed requirements of aviation turbine fuels.

| Property | Test Method(s) | Jet A or Jet A-1 |
|---|---|---|
| COMPOSITION | | |
| Acidity, total mg KOH/g, max | ASTM D3242/IP 354 | 0.10 |
| Aromatics: | | |
| (1) Percent by volume, max | ASTM D1319, IP 156, ASTM | 25 |
| | D8267, ASTM D8305 | |
| (2) Percent by volume, max | ASTM D6379/IP 436 | 26.5 |
| Sulfur, mercaptan, percent by | ASTM D3227/IP 342 | 0.003 |
| mass, max | | |
| Sulfur, total percent by mass, | ASTM D1266, ASTM D2622, | 0.30 |
| max | ASTM D4294, ASTM D5453, | |
| | IP 336 | |
| VOLATILITY | | |
| Distillation temperature, ° C.: | ASTM D86, ASTM D2887/IP | |
| | 406, ASTM D7344, ASTM | |
| | D7345, IP 123 | |
| 10% recovered, temperature, | | 205 |
| max | | |
| 50% recovered, temperature, | | Report |
| max | | |
| 90% recovered, temperature, | | Report |
| max | | |
| Final boiling point, | | 300 |
| temperature, max | | |
| Distillation residue, %, max | | 1.5 |
| Distillation loss, %, max | | 1.5 |
| Flash point, ° C., min | ASTM D56, ASTM D93, | 38 |
| | ASTM D3828, ASTM D7236, | |
| | IP 170, IP 523, IP 534 | |
| Density at 15° C., kg/m3 | ASTM D1298, IP 160, ASTM | 775 to 840 |
| | D4052, IP 365 | |
| FLUIDITY | | |
| Freezing point, ° C., max | ASTM D2386/IP 16, ASTM | −40, Jet A |
| | D5972/IP 435, ASTM | −47, Jet A-1 |
| | D7153/IP 529, ASTM D7154, | |
| | IP 528 | |
| Viscosity −20° C., mm²/s, max | ASTM D445 or IP 71, Section | 8.0 |
| | 1, ASTM D7042, ASTM | |
| | D7645 | |
| COMBUSTION | | |
| Net heat of combustion, | ASTM D4809, ASTM D4529, | 42.8 |
| MJ/kg, min | ASTM D3338, IP 12 | |
| One of the following | | |
| requirements shall be met: | | |
| (1) Smoke point, mm, min or | ASTM D1322/IP 598 | 25.0 |
| (2) Smoke point, mm, min and | ASTM D1322/IP 598, ASTM | 18.0 (Smoke point, mm, min) |
| naphthalenes, volume, | D1840, ASTM D8305 | and 3.0 (naphthalenes, |
| percent, max | | volume, percent, max) |
| CORROSION | | |
| Copper strip, 2 h at 100° C., | ASTM D130 or IP 154 | No. 1 |
| max | | |
| THERMAL STABILITY | | |
| (2.5 h at control temperature | | |
| of 260° C. min) | | |
| Filter pressure drop, mm Hg, | ASTM D3241/IP 323 | 25 |
| max | | |
| Tube rating: One of the | | |
| following requirements shall | | |
| be met: | | |
| (1) Annex A1 VTR, VTR | | 3 (no peacock or abnormal |
| color code, less than | | color deposits) |
| (2) Annex A2 ITR or Annex 3 | | 85 |
| ETR, or Annex A4 MWETR, | | |
| nm average over area of 2.5 | | |
| mm², max | | |
| CONTAMINANTS | | |
| Existent gum, mg/100 mL, | ASTM D381, IP 540 | 7 |
| max | | |
| Microseparometer, rating, | ASTM D3948 | 85 (without electrical |
| min, without electrical | | conductivity additive), 70 |
| conductivity additive, with | | (with electrical conductivity |
| electrical conductivity | | additive) |
| additive | | |
| ADDITIVES | | |
| Electrical conductivity, pS/m | ASTM D2624/IP 274 | If electrical conductivity |
| | | additive is used, the |
| | | conductivity shall not exceed |
| | | 600 pS/m at the point of use |
| | | of the fuel. When electrical |
| | | conductivity additive is |
| | | specified by the purchaser, the |
| | | conductivity shall be 50 pS/m |
| | | to 600 pS/m under the |
| | | conditions at point of delivery |
| | | (1 pS/m = 1 × 10⁻¹² Ω⁻¹m⁻¹) |

In the above table, “Report” means there are no limits for this property in the ASTM D7566 standard, but a test result should be provided because it provides useful information, and because there potentially may be a contractual limit.

The Table 1 specifications of the ASTM D1655 and D7566 are similar in many regards, but do differ in some regards. The present jet fuel may meet any suitable combination of the specifications of Table 1 of either or both standards. Illustratively, the jet fuel may meet the Table 1 specifications of the ASTM D7566 standard, other than the requirement that the jet fuel be a jet fuel blend including a conventional blending component and a synthetic blending component specified in one of Annexes A1-A8. For example, among other things, the jet fuel may include 8-25 vol % aromatics. In other examples, the jet fuel may include about 1-8 vol % aromatics, in which case the jet fuel would not meet the aromatics requirement of ASTM D7566 but nonetheless would meet the aromatics requirement of ASTM D1655.

In some examples, the jet fuel has a normally distributed carbon number distribution ranging from C7-C18 with about 20-30 mass % n-paraffins, about 25-35 mass % i-paraffins, about 35-45 mass % cycloparaffins, and about 0-10% mass aromatics. Nonlimiting examples of the present jet fuel are described with reference to FIGS. 1B and 2A-2B and the working examples. For example, either the cut or the mixture optionally further may be isomerized, and/or the hydroprocessing may be performed adiabatically. The lipid feedstock may have a TAN of about 10 mg KOH/g and/or the jet fuel may have a TAN of less than about 0.1 mg KOH/g.

It will be appreciated that a wide variety of jet fuels and jet fuel blends are provided herein. The properties of the jet fuel or fuel blend may be controlled via the IBP and EP of the particular distillation cut selected in operation 130, the amount and type of hydroprocessing performed in operation 130, the particular second blending component (e.g., conventional and/or synthetic blending component), if any, with which the present synthetic blending component (hydroprocessed distillation cut) is blended, and the relative amounts of the hydroprocessed distillation cut and second blending component in the fuel blend. The amount of carbon in the jet fuel or jet fuel blend which is from a biological source (e.g., is renewable) depends on the particular proportion of the present synthetic blending component to the second blending component with which the present synthetic blending component (if any) is blended, and the source from which the second blending component is derived. In examples in which the present synthetic blending component is blended with a renewable second blending component (such as in Annex A2, A6, or A8 of ASTM D7566), at least 90% of carbon, or even at least 95% of carbon, or even up to 100% of carbon in the fuel blend may be from a biological source. In examples in which the present synthetic blending component is blended with a conventional blending component, the amount of carbon in the fuel blend which is from a biological source is proportional to the amount of the synthetic blending component in the jet fuel blend.

It has previously been expected that to be useful as fuels, lipid feedstocks would need to be directly hydroprocessed. However, it has been discovered that the systems and methods described with reference to FIGS. 1A-1B and 2A-2B may be used to produce a mixture of components, including an intermediate composition, that surprisingly may be used as a jet fuel or in a jet fuel blend following hydroprocessing. Without being bound by a particular theory, it is believed that in the present systems and methods, heavier components of the mixture that have a boiling point that is too high for evaporation under the conditions in the reaction vessel tend to remain in the liquid phase in the reaction vessel until they convert further into lighter products that evaporate in the reaction vessel and are carried out of the reaction vessel with the treated stream. It is further understood that the systems and methods described with reference to FIGS. 1A-1B and 2A-2B restructure the carbon chains in the fatty acids of the lipids. In some examples, the intermediate composition is or includes a mixture of essentially non-acidic hydrocarbons and oxygenates, primarily ketones, with chain lengths varying from significantly shorter than the original fatty acid chain length to considerably longer than the original fatty acid chain length. This phenomenon yields a mixture, including an intermediate composition, that is particularly useful for producing products in the aviation turbine fuel range, e.g., jet fuels and/or jet fuel blends, e.g., using systems and operations such as described with reference to FIGS. 1A-1B, 2A-2B, and 3.

In some examples, the mixture, including the intermediate composition, exiting reaction vessel 210 may be fractionated before or after hydroprocessing into a plurality of different components, the cut points of which may be tailored to the desired fuels. Nonlimiting examples of components that may be obtained using hydroprocessing and/or fractionation, in addition to the present jet fuel or synthetic blending component, include: 1) renewable fuel gas including (and, in some examples, consisting essentially of) C1 and C2 hydrocarbons with a boiling point range of about 0° C. to about 20° C., 2) a renewable liquefied petroleum gas (LPG) including (and, in some examples, consisting essentially of) C3 and C4 hydrocarbons with a boiling point range of about 20° C. to about 150° C., 3) a renewable intermediate transportation fuel including (and, in some examples, consisting essentially of) hydrocarbons in the range of C5 to C20 with a boiling point range of about 150° C. to about 360° C., and/or 4) a heavy ends product including (and, in some examples, consisting essentially of) hydrocarbons in the range of C21 to C35 with a boiling point range of about 360° C. to about 490° C. Such separation may be performed, for example, using distillation in a manner such as known in the art.

In some examples, the mixture, including the intermediate composition, obtained using operations 110-120 described with reference to FIGS. 1A-1B may include a liquid having the following characteristics:
(1) naphtha (boiling point of about 20° C. to about 100-150° C.) of greater than 10 wt % and less than about 30 wt % in the intermediate composition;
(2) intermediate transportation fuel (boiling point of about 100-150° C. to about 360° C.) of greater than about 40 wt % and less than about 60 wt % in the intermediate composition; and
(3) heavy ends product (boiling point of about 360° C. to about 490° C.) of less than about 30 wt % in the intermediate composition.

In some examples, the liquid portion of the mixture may be further characterized as having greater than 90% of its carbon content being renewable carbon of biological (as opposed to fossil/mineral) origin as measured by standard C14 radiocarbon analysis. In some examples, the liquid portion of the mixture may be further, or alternatively, characterized as having an oxygen content in the range of 1-4 wt %. In some examples, the liquid portion of the mixture can be further, or alternatively, characterized as having an NMR branching index of greater than about 14%, wherein the NMR branching index is defined as the integral of the protons in the methyl region of 0.5 to 0.95 ppm as a percentage of the integral of the entire aliphatic proton resonances region of 0.5 to 2.1 ppm. In some examples, the liquid portion of the mixture may be further, or alternatively, characterized as having about 10 wt % to about 50 wt % of oxygen containing molecules and/or at least about 50 wt % of oxygen-free hydrocarbons.

In some examples, the liquid portion of the mixture can be further, or alternatively, characterized as having more than about 70 wt %, or more than about 80 wt %, of the oxygen in the product being in the form of ketone groups. Additionally, or alternatively, in some examples, the liquid portion of the mixture may be characterized as having and at least about 10 wt % of the oxygen in the form of methyl ketones (Me-C(O)—R).

In some examples, the liquid portion of the mixture can be further, or alternatively, characterized as having a total acid number (TAN) of less than 1.

In one nonlimiting example, an intermediate transportation (e.g., aviation) fuel portion of the liquid renewable fuel intermediate composition that is suitable for further processing into aviation turbine fuel (e.g., jet fuel or a jet fuel blend) may be characterized as:
(1) having greater than 90% of its carbon content being renewable carbon of biological (as opposed to fossil/mineral) origin as measured by standard C14 radiocarbon analysis;
(2) having a freezing point of less than about −15° C.;
(3) having less than about 10 wt % of its content comprising acyclic isoalkanes; and
(4) having greater than about 15 wt %, (e.g., greater than about 20 wt %, or greater than about 30 wt %) of its content being saturated hydrocarbons with one or two rings (i.e., cycloalkanes).

In some examples, the intermediate composition can be further, or alternatively, characterized as a composition in which the fraction of saturated hydrocarbons with one or two rings is at least twice the fraction of saturated acyclic hydrocarbons (i.e., traditional isoalkanes). In some examples, the intermediate composition can be further characterized as a composition in which the fraction of saturated hydrocarbons with one or two rings is larger than the fraction of saturated acyclic hydrocarbons (i.e., traditional isoalkanes).

As noted above, transportation fuels have to meet certain specifications. The cold flow properties of aviation turbine fuels may be particularly challenging when making renewable fuels from lipid feedstock. For example, lipids may include linear molecular components which, in previously known methods, tend to hydrotreat to predominantly linear products, which may have relatively high pour, cloud, and freeze points. Consequently, renewable fuels produced using previously known methods may need extensive isomerization/dewaxing to meet the cold flow property specification. The specifications for aviation turbine fuels, in particular, have a relatively low freeze point (i.e., −40° C. for Jet A, −47° C. for Jet A-1, and −60° C. for Jet B).

Additional examples of jet fuels and jet fuel blends made using the present systems and methods will be apparent based on the present disclosure.

### Working Examples

The following examples are intended to be purely illustrative, and not limiting of the present subject matter.

In some examples, intermediate compositions made using the present systems and methods may be used to produce a finished aviation turbine fuel (particularly jet fuel, such as Jet A or Jet A-1). For example, it is expected that when the renewable fuel intermediate composition is hydroprocessed in a manner such as described with reference to FIGS. 1A-1B, 2A-2F, 3A-3F, and 4, the jet fuel range fraction of the finished aviation turbine fuel will have a suitable freezing point. In one nonlimiting example, the finished aviation turbine fuel may be characterized as having:
(1) a carbon content of which at least about 90% is derived from biological origin as determined by carbon-14 presence;
(2) a bromine index less than about 1000;
(3) an oxygen content less than about 1 wt %; and
(4) a cycloalkane content having one or two rings, the cycloalkane content comprising greater than 15 wt %.

In some examples, the finished aviation turbine fuel may be further, or alternatively, characterized as having a jet fuel component that has a freezing point less than about −15° C., or less than about −20° C., or less than about −30° C., or less than about −40° C., or about −40° C., or about −47° C.

In some examples, the finished aviation turbine fuel may be further, or alternatively, characterized as having an n-alkane content of less than about 70 wt %, or less than about 60 wt %.

In some examples, the finished aviation turbine fuel may be further, or alternatively, characterized as having an acyclic isoalkane content of less than about 15 wt %.

In some examples, the finished aviation turbine fuel may be further, or alternatively, characterized as having a cycloalkane content that is at least about twice an acyclic isoalkane content as measured by weight percent of the finished aviation fuel.

In some examples, the finished aviation turbine fuel may be further, or alternatively, characterized as having mono-aromatic components greater than about 2 wt % and less than about 15 wt %.

Additional examples of finished aviation turbine fuel will be elucidated below with reference to example data.

### WORKING EXAMPLES

The following examples are intended to be purely illustrative, and not limiting of the present subject matter.

### Example 1. Preparation of Renewable Fuel Intermediate Composition

A calcium oxide catalyst on alumina support was prepared by treating alumina with 17 wt % calcium acetate in water, drying at 120-140° C., and calcining at 480° C. The calcium oxide catalyst on alumina support had a packed density in the range of about 0.85 g/cc to about 0.95 g/cc; a pore volume in the range of about 0.44 to about 0.46 cc/g; a large pore content (pores>1000 Å) of about 0.33 cc/g to about 0.36 cc/g; an average pore diameter (D50) of about 130 Å to about 160 Å; and a surface area of about 80 m²/g to about 120 m²/g.

In the manner described with reference to operations 110 and 120 of FIGS. 1A and 1B and reactor 210 of FIGS. 2A and 2B, the example lipid feedstock soybean oil (SBO) was flowed over a fixed-bed calcium oxide catalyst on an alumina support, in the presence of hydrogen, to generate a mixture including an intermediate composition. The reaction was performed at 900° F. (about 482° C.) at the following combinations of conditions: a liquid hourly space velocity (LHSV, oil feed basis) of about 1.05 h⁻¹ and a reaction vessel pressure (start of run) of 100 psig.

Table 2 below lists selected properties of the lipid feedstock (feeds), intermediate compositions (prod.) generated using such feedstock, and reaction conditions used during the catalytic conversion. The concentrations of impurities Ca, Fe, K, Mg, Na, Ni, P, Si, Sn, and V were measured using inductively coupled plasma-mass spectrometry (ICP). Where the less-than symbol (<) is used in Table 2, it means that the concentration of the impurity was below the instrument's resolution for that impurity in that run (e.g., that the impurity was undetectable).

TABLE 2

| | SBO Feed | SBO Prod. |
|---|---|---|
| Reaction vessel Temp. (° F.) | | 900 |
| Reaction vessel outlet | | 100 |
| pressure, start of run (psig) | | |
| LHSV, oil feed basis, (h⁻¹) | | 1.05 |
| [Ca] (ppm) | 0.247 | <0.1 |
| [Fe] (ppm) | <0.21 | <0.2 |
| [K] (ppm) | <0.41 | <0.4 |
| [Mg] (ppm) | <0.11 | <0.1 |
| [Na] (ppm) | <0.21 | 3.7 |
| [Ni] (ppm) | <0.021 | <0.021 |
| [P] (ppm) | <0.21 | <0.21 |
| [Si] (ppm) | 0.21 | 1.02 |
| [Sn] (ppm) | <0.31 | <0.3 |
| [V] (ppm) | <0.11 | <0.1 |
| NMR Branching index* | 11% | 19% |
| Average carbon number per | 12.7 | 23.1 |
| olefin | | |
| R—CH═CH—R′ in olefins | 100% | 44% |
| R—CH═CH₂ in olefins | 0% | 50% |

*Refers to methyl 1H in total aliphatic 1H resonances

From Table 2, it may be understood that a lipid feedstock having impurities was catalytically converted to a mixture including an intermediate composition (also referred to herein as ketopyrolysate).

The intermediate composition, and the feedstock from which the intermediate composition was derived, were characterized in a variety of ways. For example, the SBO feedstock had 100% of its olefins in the form of R—CH═CH—R′ and 0% of its olefins in the form of R—CH—CH₂, while the SBO intermediate composition had 44% of its olefins in the form of R—CH═CH—R′ and 50% of its olefins in the form of R—CH—CH₂. A relatively average carbon number per olefin is useful because higher carbon number per olefin means fewer double bonds and thus less hydrogen consumption and lower hydrogenation exotherm in subsequent hydrotreating. Additionally, the terminal olefins are formed by cracking reactions and reflect that longer chains have cracked. The fact that the total olefin count is not increasing as much reflects that some of the internal double bond from the feed appear to disappear and it is believed, without wishing to be bound by any theory, that is because there are cyclics formed (e.g., naphthenic products).

Additionally, from Table 2 it may be understood that the intermediate composition formed using catalytic processing of the lipid feedstock had significantly increased branching compared to its feedstock, as reflected by the NMR branching index. More specifically, the SBO feedstock had an NMR branching index of 11%, while the SBO intermediate composition had an NMR branching index of 19%, an increase of about 70%. It is useful for the NMR branching index of the intermediate composition to be higher than that of the respective feedstock because increased branching reflects that the product is not as linear as the feedstock. This is consistent with the formation of cyclic products, which improve coldflow properties of the hydrogenated final product. This is important, for example, because linear alkanes in the transportation fuel range have high melting points and freeze when cooled. Because of the higher branching of the present lipid feedstocks' intermediate compositions, the intermediate compositions may not require as severe a hydroisomerization and directly hydrogenated lipids do.

Additionally, from Table 2 it may be understood that the catalytic processing of the lipid feedstock reduced the levels of all measured impurities to below the ICP instrument's resolution. That is, catalytic processing such as described with reference to operations 110 and 120 and reactor 210 substantially removed all of the measured impurities, which included metals (Fe, Ni, Sn, V), a pseudometal (Si), alkali metals (Na, K), alkaline earth metals (Mg, Ca), and a nonmetal (P).

Boiling point curves for the SBO feedstock and SBO intermediate composition were also obtained, to characterize the distribution of molecules respectively within them. Simulated distillation (SIMDIS) was determined according to ASTM D2887. Table 3 summarizes the SIMDIS data.

TABLE 3

| % distilled | SBO Feed wt % | SBO Prod. wt % |
|---|---|---|
| 0.5 | 846 | 317 |
| 5 | 938 | 320 |
| 10 | 1102 | 327 |
| 15 | 1110 | 342 |
| 20 | 1114 | 369 |
| 25 | 1118 | 406 |
| 30 | 1120 | 433 |
| 35 | 1122 | 481 |
| 40 | 1124 | 513 |
| 45 | 1125 | 539 |
| 50 | 1126 | 566 |
| 55 | 1127 | 595 |
| 60 | 1128 | 625 |
| 65 | 1129 | 659 |
| 70 | 1130 | 683 |
| 75 | 1132 | 718 |
| 80 | 1133 | 754 |
| 85 | 1135 | 793 |
| 90 | 1137 | 844 |
| 95 | 1141 | 906 |
| 99.5 | 1158 | 1034 |

From these data, it may be understood that the systems and methods described with reference to operations 110 and 120 and reactor 210 suitably may be used to generate intermediate compositions using lipid feedstocks.

### Example 2. Preparation of Finished Aviation Turbine Fuel

The whole liquid product (mixture including intermediate composition) was then hydroprocessed in the manner described with reference to operation 130 of FIGS. 1A-1B, in hydroprocessor(s) 240 configured such as described with reference to FIGS. 2A-2B. The product had a flash point of 38° C. and a freeze point of −45.4° C. Both properties met Jet A specifications. Detailed product properties are summarized in Table 4. As may be understood from Table 4, the freeze point of the product may further be lowered to meet Jet A-1 specifications by lowering the distillation end point.

TABLE 4
Properties of hydroprocessed cut

| Property | Value | Method Used | Min/Max |
|---|---|---|---|
| Acidity, total mg KOH/g | <0.005 | D3242 | Max |
| T10, ° C. | 167 | D86 | Max |
| T50, ° C. | 218 | D86 | report |
| T90, ° C. | 263 | D86 | report |
| FBP, ° C. | 276 | D86 | Max |
| T90-T10, ° C. | 97 | D86 | Min |
| Distillation residue, % | 1.2 | D86 | Max |
| Distillation loss, % | 0.4 | D86 | Max |
| T10, ° C. | 147.3 | D2887 | report |
| T20, ° C. | 169.4 | D2887 | report |
| T50, ° C. | 217.4 | D2887 | report |
| T80, ° C. | 266.1 | D2887 | report |
| T90, ° C. | 281.9 | D2887 | report |
| FBP, ° C. | 302 | D2887 | report |
| Flash point, ° C. | 38 | D56 | Min |
| Density at 15° C., kg/m³ | 0.785 | D4052 | |
| Freezing Point, ° C. | −45.4 | D5972 | Max |
| Existent Gum, mg/100 mL | Not Tested | IP 540 | Max |
| Existent Gum, mg/100 mL | 2 | D381 | Max |
| FAME, mg/kg | <4.5 | IP 585 | Max |
| JFTOT ETR @ 325° C., nm | 9.7 | D3241 | Max |
| JFTOT VTR @ 325° C. | 1 | D3241 | Less than |
| JFTOT dP, mmHg | 0 | D3241 | Max |
| Cycloparaffins, mass % | 44.7 | D2425 | Max |
| Aromatics, mass % | 3.5 | D2425 | Max |
| Paraffins, mass % | 51.8 | D2425 | report |
| Carbon and Hydrogen, mass % | 100.71 | D5921 | Min |
| Nitrogen, mg/kg | <0.3 | D4629 | Max |
| Water, mg/kg | 23 | D6304 | Max |
| Sulfur, mg/kg | <5 | | Max |
| Metals | Below Detection | | Max |
| Halogens, mg/kg | Below Detection | | Max |
| Viscosity @ −20 C., cSt | 4.984 | | |
| Viscosity @ −40 C., cSt | 10.31 | | |
| Net Heat of Combustion, MJ/kg | 43.72 | | |
| Smoke Point, mm | 38 | | |

From Table 4, it may be understood that the synthetic blending component meets all of the Table 1 requirements in D7566. It also has favorable properties such as higher cycloparaffin content compared to an Annex A2 SBC and has a surprisingly low freezing point for a lipid derived material. It also has extremely low (non-detect) heteroatom content and excellent thermal stability.

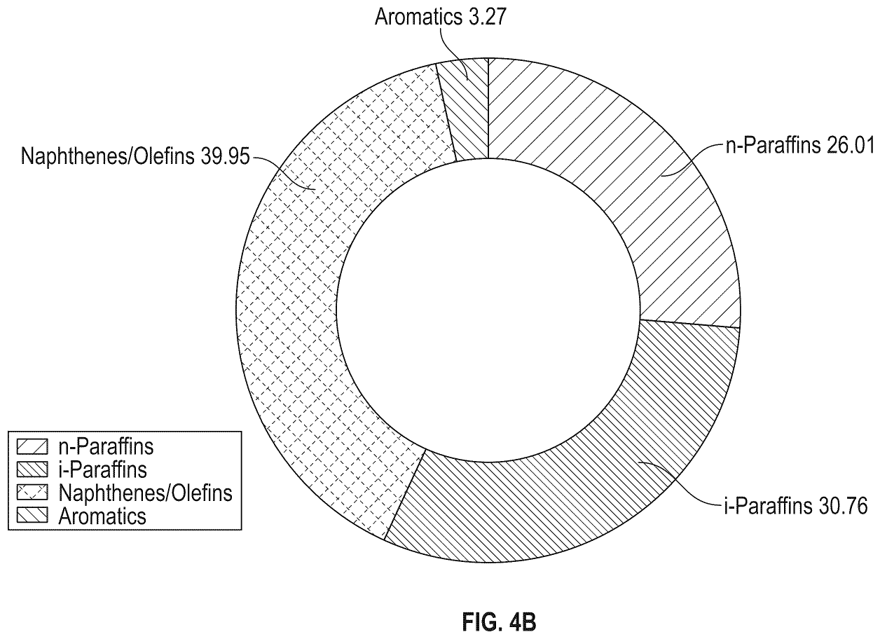

FIGS. 4A-4B are plots illustrating the bulk composition of the present synthetic blending component. The carbon number (FIG. 4A) and group type distribution (FIG. 4B) are very close to what would be seen in a conventional jet fuel, the main difference being the low aromatic content. Overall, the closest conventional component would be a hydrocracked jet fuel which often has low aromatic content and high cycloparaffin content due to the severe hydroprocessing. It may be understood that the present fuel could likely be used as a drop-in jet fuel, especially if process conditions are optimized to increase the aromatic content.

From the foregoing, it may be understood that systems and methods such as described with reference to FIGS. 1A-1B, 2A-2B, and 3 suitably may be used to generate finished jet fuel and jet fuel blends under a wide variety of reaction conditions.

### Additional Comments

While various illustrative embodiments of the invention are described above, it will be apparent to one skilled in the art that various changes and modifications can be made therein without departing from the invention. The appended claims are intended to cover all such changes and modifications that fall within the true spirit and scope of the invention.

1. A method of generating a fuel blend, the method comprising:
flowing a lipid feedstock comprising fatty acid glycerol esters into a reaction vessel comprising a metal oxide catalyst on an oxide support;
using the metal oxide catalyst in the reaction vessel to catalytically convert the lipid feedstock into a mixture comprising an intermediate composition having at least 70% of its oxygen within ketone groups;
obtaining a synthetic blending component having a boiling range of about 120° C. to about 300° C. using operations comprising either (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture;
blending the synthetic blending component with a second blending component to create a jet fuel blend having a flash point of about 38° C. or more, a freeze point of about −40° C. or less, a viscosity at −20° C. of about 8 mm²/s or less, and a viscosity at −40° C. of about 12 mm²/s or less.

2. (canceled)

3. The method of claim 1, wherein about 1-50 vol % of the jet fuel blend is the synthetic blending component.

4. The method of claim 3, wherein the second blending component comprises a conventional blending component, and wherein the jet fuel blend meets the Table 1 specifications of the ASTM D7566 standard, other than the requirement that the synthetic blending component is specified in one of Annexes A1-A8.

5. The method of claim 3, wherein the second blending component comprises a second synthetic blending component, and wherein the jet fuel blend meets the Table 1 specifications of the ASTM D7566 standard, other than the requirements that the synthetic blending component is specified in one of Annexes A1-A8 and that the second blending component be a conventional blending component.

6. The method of claim 1, wherein about 50-99 vol % of the jet fuel blend is the synthetic blending component.

7. The method of claim 6, wherein the second blending component comprises a conventional blending component, and wherein the jet fuel blend meets the Table 1 specifications of the ASTM D7566 standard, other than the requirements that the synthetic blending component is specified in one of Annexes A1-A8 and that no more than 50 vol % of the jet fuel blend be the synthetic blending component.

8. The method of claim 6, wherein the second blending component comprises a second synthetic blending component, and wherein the jet fuel blend meets the Table 1 specifications of the ASTM D7566 standard, other than the requirements that the synthetic blending component is specified in one of Annexes A1-A8, that no more than 50 vol % of the jet fuel blend be the synthetic blending component, and that the second blending component be a conventional blending component.

9. The method of claim 1, wherein the second blending component comprises hydrotreated jet boiling range material from lipids processed through an FCC unit.

10. The method of claim 1, wherein the second blending component comprises ASTM D7566 Annex A6 synthetic blending component or ASTM D7566 Annex A8 synthetic blending component.

11. (canceled)

12. The method of claim 9, to wherein the jet fuel blend comprises about 8-25 vol % aromatics, and wherein the jet fuel blend meets the Table 1 specifications of the ASTM D7566 standard, other the requirement that the second blending component be a conventional blending component.

13. The method of claim 1, wherein the jet fuel blend comprises about 1-8 vol % aromatics.

14. The method of claim 1, wherein the synthetic blending component has a normally distributed carbon number distribution ranging from C7-C18 with about 20-30 mass % n-paraffins, about 25-35 mass % i-paraffins, about 35-45 mass % cycloparaffins, and about 0-10% mass aromatics.

15. The method of claim 1, wherein the jet fuel blend consists essentially of sustainable aviation fuel.

16. The method of claim 1, wherein the jet fuel blend consists essentially of the synthetic blending component and the second blending component.

17. The method of claim 1, wherein the jet fuel blend has a freeze point of less than about −47° C.

18. The method of claim 1, wherein the second blending component has a viscosity at −40° C. of more than 12 mm²/s.

19. The method of claim 1, wherein either the cut or the mixture further is isomerized.

20. The method of claim 1, wherein the lipid feedstock has a TAN of about 10 mg KOH/g.

21. The method of claim 1, wherein the jet fuel blend has a TAN of less than about 0.1 mg KOH/g.

22. The method of claim 1, wherein the hydroprocessing is performed adiabatically.

23. A jet fuel blend, comprising:
a synthetic blending component having a generally normally distributed carbon number distribution ranging from C7-C18 with about 20-30 mass % n-paraffins, about 25-35 mass % i-paraffins, about 35-45 mass % cycloparaffins, and about 0-10% mass aromatics; and
a second blending component,
the jet fuel blend having a flash point of about 38° C. or more, a freeze point of about −40° C. or less, a viscosity at −20° C. of about 8 mm²/s or less, and a viscosity at −40° C. of about 12 mm²/s or less.

24. A jet fuel blend, comprising:
a synthetic blending component made using operations comprising:
flowing a lipid feedstock comprising fatty acid glycerol esters into a reaction vessel comprising a metal oxide catalyst on an oxide support;
using the metal oxide catalyst in the reaction vessel to catalytically convert the lipid feedstock into a mixture comprising an intermediate composition having at least 70% of its oxygen within ketone groups;
obtaining a synthetic blending component having a boiling range of about 120° C. to about 300° C. using operations comprising either (i) using fractionation to obtain a cut of the mixture and then saturating and hydrodeoxygenating the cut, or (ii) saturating and hydrodeoxygenating the mixture and then using fractionation to obtain a cut of the saturated, hydrodeoxygenated mixture; and
a second blending component,
the jet fuel blend having a flash point of about 38° C. or more, a freeze point of about −40° C. or less, a viscosity at −20° C. of about 8 mm²/s or less, and a viscosity at −40° C. of about 12 mm²/s or less.

25-64. (canceled)
